(19) United States
(12) Patent Application Publication
(10) Pub. No.: US 2005/0277855 A1
(43) Pub. Date: Dec. 15, 2005

(54) Device for suppressing roaring of pet

(75) Inventors: Kazunari Tanaka, Takefu-city (JP); Shizuo Yamaguchi, Takefu-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Takefu-city (JP)

(21) Appl. No.: 11/147,457

(22) Filed: Jun. 8, 2005

(30) Foreign Application Priority Data
Jun. 10, 2004 (JP) 2004-173048

(51) Int. Cl. A61H 1/00

(52) U.S. Cl. 601/46

(57) ABSTRACT

The invention provides a device for suppressing roaring of pet that enables the pet owner to control the action of the pet according to circumstances, with reduced power consumption and low running cost. A receiver 15 detects the barking of a dog, and based on the audio signal, it is set to receive mode for a predetermined period of time. When the pet owner hears the barking and determines that it is an unnecessary bark, he/she manipulates a transmitter 11. If the receiver 15 is at receive mode, when a signal is output from the receiver 15, a vibration unit 10 is activated, applying vibration to the pet and suppressing the roaring of the pet. If no signal from the transmitter 11 is received during the predetermined period of time, the receiver 15 enters a standby status. Thus, there is no need to supply power constantly to the receiver 15, and the power consumption of the receiver 15 can be cut down.

The present application is based on and claims priority of Japanese patent application No. 2004-173048 filed on Jun. 10, 2004, the entire contents of which are hereby incorporated by reference.

### BACKGROUND OF THE INVENTION

1. Field of the Invention

The present invention relates to a device for suppressing roaring of pet, used for example to control the unnecessary barking of a pet dog.

2. Description of the Related Art

Heretofore, dogs are kept at homes as pets, but the barking of the pet dogs at early mornings and midnights have caused noise problems among the neighbors, leading to serious trouble. Therefore, Japanese Patent Application Laid-Open Publication No. 2002-171860 (patent document 1) discloses a collar to be attached to the neck of a dog, having a voice recognition sensor which sends a detection signal when the barking of a dog is detected, and a vibration unit which is vibrated when the barking of the dog is detected by the voice recognition sensor, so that the vibration unit is activated by the barking of the dog in order to prevent the barking. Further, Japanese Patent Application Laid-Open Publication No. 2003-158940 (patent document 2) discloses a pet collar having a training function, that enables training of the pet by attaching a vibration element and/or a sound generating element to the collar and controlling the elements by a remote control device or the like or turning on/off the vibration element and the sound generating element simultaneously or intermittently or by combining long and short control signals.

The essential object of such pet collar is to suppress unnecessary barking and excessive roaring to train the pet not to bark more than necessary. However, according to the collar for preventing barking disclosed in patent document 1, the vibration unit activates automatically when the barking of the pet is detected under any condition. Therefore, even if the pet is making a soft sound to call for the attention of the owner, the vibration unit is activated, and it is impossible for the pet to recognize what kind of behavior (unnecessary barking) is bad. As a result, the pet may not bark at all or may loose the trust it has on people, or the trusting relationship between the pet and the pet owner may be deteriorated. On the other hand, according to the pet collar having the training function disclosed in patent document 2, the pet owner can control the activation of the vibration element and the sound generating element by remote control when the pet behaves badly. However, according to the pet collar having the training function disclosed in patent document 2, the collar is constantly at receive mode, so that if a battery is used as the power source, the consumption of power is excessive. Even further, the vibration element is activated even when the pet owner erroneously manipulates the switch on the transmitter.

### SUMMARY OF THE INVENTION

The present invention aims at solving the problems of the prior art, by providing a device for suppressing roaring of a pet that enables the pet owner to control the behavior of the pet according to circumstances, that consumes less power and prevents erroneous operation.

The device for suppressing roaring of pet according to a first aspect of the present invention is a device for suppressing roaring of the pet by attaching to a collar of the pet, the device comprising a roaring suppressing means for suppressing the roaring of the pet by applying stimulus to the pet, a transmitting means carried by a pet owner for remote-controlling the roaring suppressing means, a receiving means for receiving a signal from the transmitting means, and a control means for detecting the barking of the pet, and controlling based on the audio signal to enable communication between the transmitting means and the receiving means f or a predetermined period of time, and to disable communication between the transmitting means and the receiving means after the passing of the predetermined period of time.

According to the above arrangement, when f or example the pet dog barks and the barking is detected, the control unit starts a timer count so as to maintain a receive mode of the receiving means only during a preset period of time (for example, 30 seconds), and cancels the receive mode after the passing of the predetermined time to enter a sleep status. Further, the pet owner can determine after hearing the yelping of the dog whether it is merely a soft call for attention or an unnecessary bark, and when he/she determines that it is an unnecessary bark, transmits a signal via the transmitter. At this time, if the receiving means is at receive mode, the suppressing means is activated, applying stimulus to the pet and suppressing roaring of the pet.

According to a second aspect of the invention, the device for suppressing roaring of pet according to the first aspect of the invention further characterizes in that a plurality of mode switches are provided in the transmitting means and the receiving means, and the control means controls to enable communication between the transmitting means and the receiving means when the mode switches of the transmitting means and the receiving means mutually correspond.

According to this arrangement, when the signal from the transmitting means is received by the receiving means, the received signal from the transmitting means input via the control means is verified, and whether the ID of the mode switch of the receiving means corresponds to the ID of the mode switch of the transmitting means is determined. Only when the ID of mode switches of the receiving means and the transmitting means correspond, the communication between the transmitting means and the receiving means is enabled.

According to a third aspect of the present invention, the device for suppressing roaring of pet according to the first and second aspects of the invention further characterize in that the roaring suppressing means comprises a vibration unit for applying vibration to the pet.

According to this arrangement, when the pet owner determines that the barking is unnecessary, he/she controls the transmission means to activate the vibration unit to apply stimulus by vibration to the pet to suppress the barking of the pet.

Since the device for suppressing roaring of the pet according to the first aspect of the invention is a device for suppressing roaring of the pet by attaching to a collar of the pet; the device comprising a roaring suppressing means for suppressing the roaring of the pet by applying stimulus to the pet, a transmitting means carried by a pet owner for remote-controlling the roaring suppressing means, a receiving means for receiving a signal from the transmitting means, and a control means for detecting the roaring of the pet, and controlling based on the audio signal to enable communication between the transmitting means and the receiving means for a predetermined period of time, and to disable communication between the transmitting means and the receiving means after the passing of the predetermined period of time; the receiving means is set to receive mode only for a predetermined period of time based on the audio signal of the barking being detected, the suppressing means will not activate even when the transmitter is manipulated during other than the receive mode. Therefore, the erroneous manipulation of the device by the pet owner will not cause unnecessary pain in the pet. Moreover, since the receiving means enters a standby state after the passing of the predetermined period of time, the receiving means is not constantly at receive mode, and the power consumption of the receiving means can be reduced and the running cost can thereby be cut down. Furthermore, it is up to the pet owner to determine whether or not to activate the suppressing means, so it becomes possible to activate the suppressing means only when the pet is barking unnecessarily or when the roaring is excessive, enabling the pet to recognize what kind of behavior (unnecessary barking) is bad. Therefore, the device can be used for effective training.

According to the second aspect of the invention, the device for suppressing roaring of pet according to the first aspect of the invention further characterizes in that a plurality of mode switches are provided to the transmitting means and the receiving means, and the control means carries out a control to enable communication between the transmitting means and the receiving means when the mode switches of the transmitting means and the receiving means mutually correspond. Therefore, the use of a remote control device for a different electric appliance using the same frequency band will not cause the suppressing means to activate erroneously.

According to a third aspect of the present invention, the device for suppressing roaring of pet according to the first and second aspects of the invention further characterize in that the roaring suppressing means comprises a vibration unit for applying vibration to the pet. Therefore, it is possible to suppress the unnecessary barking of the pet effectively by applying vibration as stimulus to the pet.

### BRIEF DESCRIPTION OF THE DRAWINGS

FIG. 1 is a perspective view showing the overall structure of a collar according to one embodiment of the present invention;

FIG. 2 is a plan view of the device for suppressing roaring according to the present invention;

FIG. 3 is a rear view thereof;

FIG. 4 is a front view of a transmitter;

FIG. 5 is a block diagram of the device for suppressing roaring;

FIG. 6 is a block diagram of the transmitter;

FIG. 7 is a circuit diagram of the device for suppressing roaring;

FIG. 8 is a circuit diagram of the transmitter;

FIG. 9 is a flowchart showing the transmission operation;

FIG. 10 is a flowchart showing the receive mode; and

FIG. 11 is a flowchart showing the vibrating action.

### DETAILED DESCRIPTION OF THE PREFERRED EMBODIMENTS

Now, the preferred embodiments for carrying out the present invention will be described with reference to the drawings.

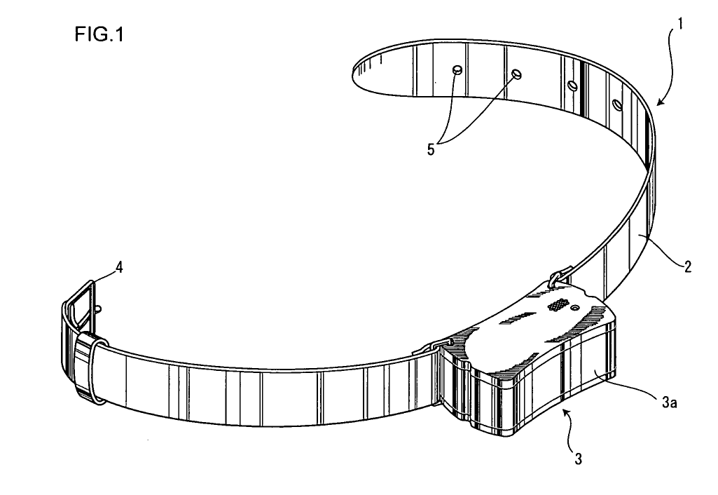

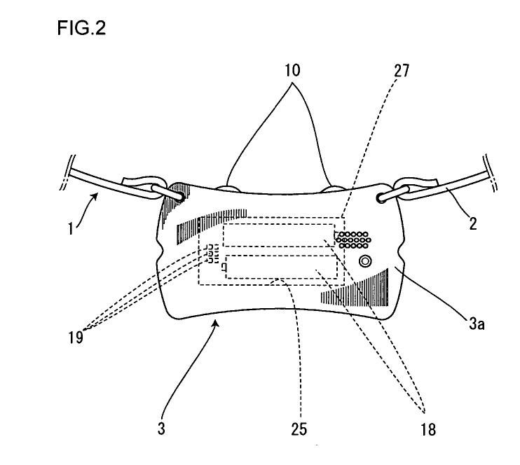

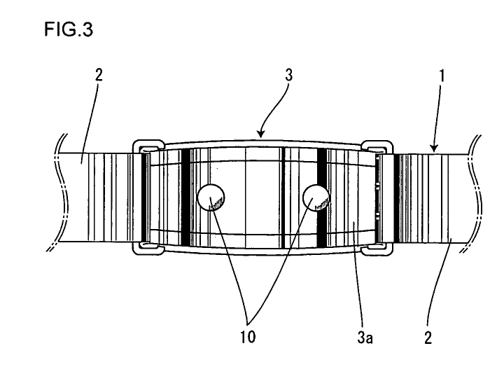

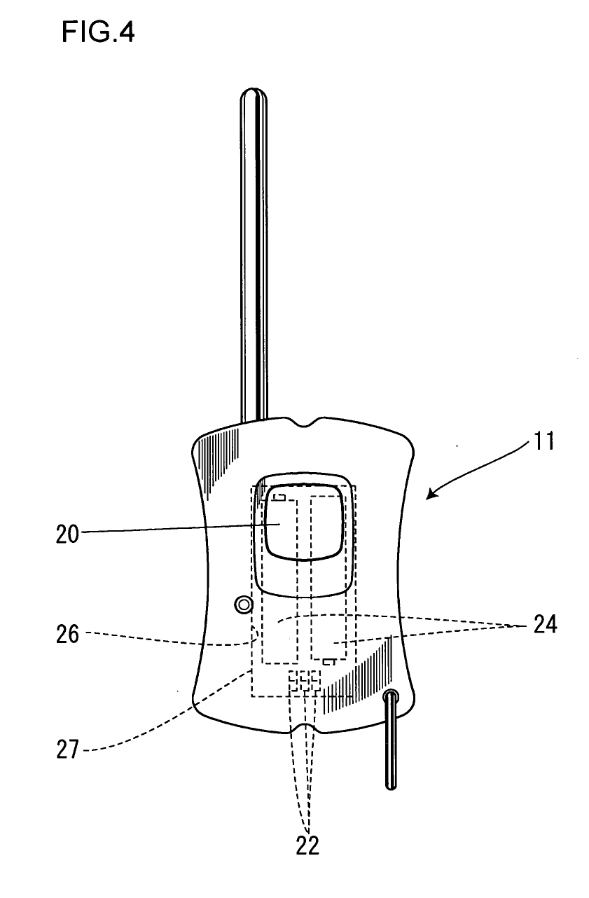

FIGS. 1 through 9 illustrate one embodiment of the present invention. FIG. 1 is an overall perspective view wherein reference number 1 denotes a collar to be attached to the neck of a dog, and a case 3a housing a device 3 for suppressing roaring is attached to the center of a belt 2 of the collar 1. A metallic buckle 4 for adjusting the length of the belt and engaging the belt annularly is fixed to one end of the belt 2, and a plurality of length adjustment holes 5 are provided at uniform intervals at the other end of the belt 2.

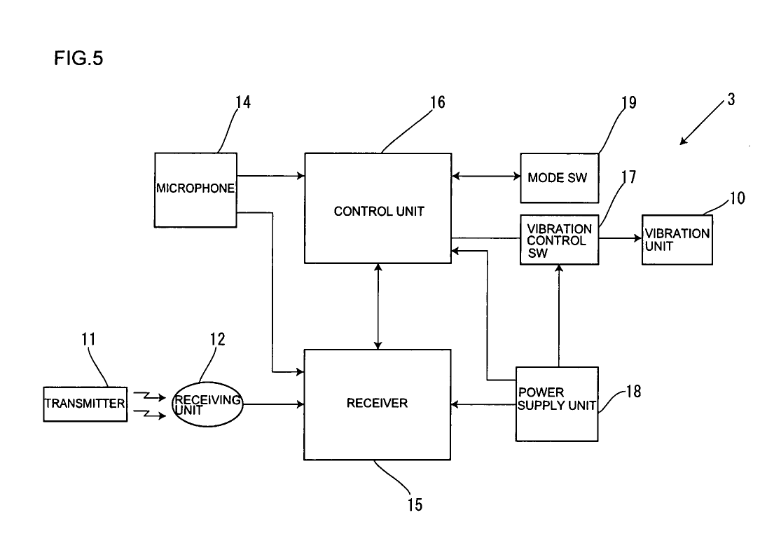

The arrangement of the device 3 for suppressing roaring is described with reference to the block diagram of FIG. 5. The device 3 for suppressing roaring according to the present invention is equipped with a vibration unit 10 that applies vibration to the pet as roaring suppressing means. The vibration unit 10 is formed for example of a vibrator that is driven by an electric motor, and the vibration unit 10 is remote-controlled via a transmitter 11 (transmitting means) carried by the pet owner. The device 3 for suppressing roaring also includes a receiving unit 12 (receiving means) for receiving signals from the transmitter 11, a receiver 15 that operates upon receiving the signals from the receiving unit 12, a microphone 14 that picks up the barking of a dog, and a control unit 16 functioning as a control means for controlling the vibration unit 10 and the receiver 15 according to the audio signal from the microphone 14. The control unit 16 determines the level of the audio signal from the microphone 14, and if it exceeds a predetermined level, enables the communication between the receiving unit 12 and the receiver 15 for a predetermined period of time, and after the passing of the predetermined period of time, disables the communication between the receiving unit 12 and the receiver 15. In the block diagram of FIG. 5, 17 denotes a vibration control switch for turning the vibration unit 10 on and off, 18 is a power supply unit and 19 is a mode switch.

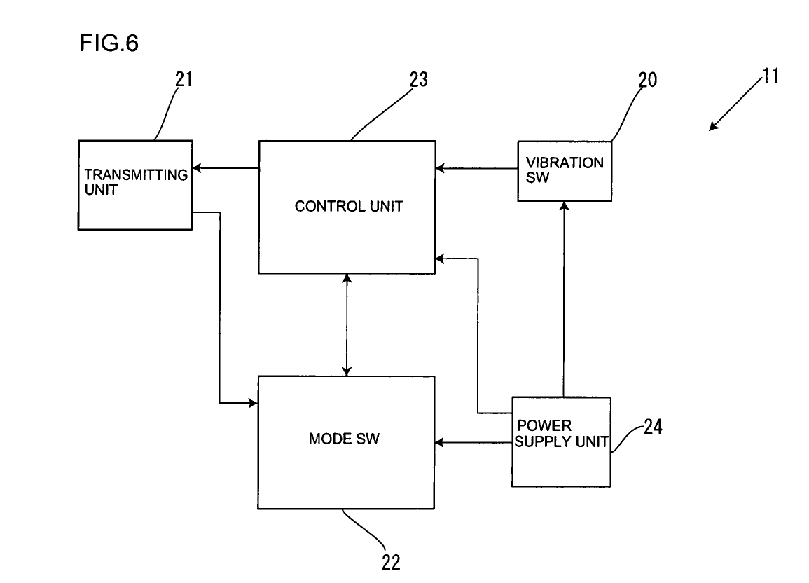

The transmitter 11 has, as shown in the block diagram of FIG. 6, a vibration switch 20 operated by the pet owner, a transmitting unit 21 for transmitting remote control signals, a mode switch 22, a control unit 23 for providing operation instructions to and controlling the operations of the vibration switch 20, the transmitting unit 21 and the mode switch 22, and a power supply unit 24. In the present embodiment, PICs (peripheral interface controllers) are used as the control units 16 and 23 built into the device 3 for suppressing roaring and the transmitter 11. Batteries are used as the power supply units 18 and 24 of the device 3 and the transmitter 11, and battery housing units 25 and 26 for housing the power supply units 18 and 24 are provided to the device 3 and the transmitter 11. Mode switches 19 and 22 are provided near the battery housing units 25 and 26, which can be manually controlled by removing a battery lid 27 covering the opening of the battery housing units 25 and 26.

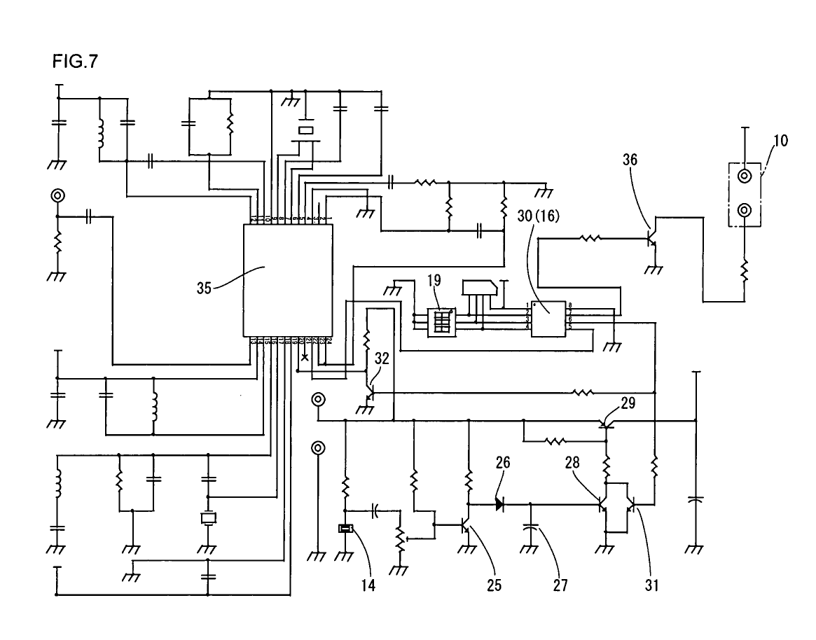

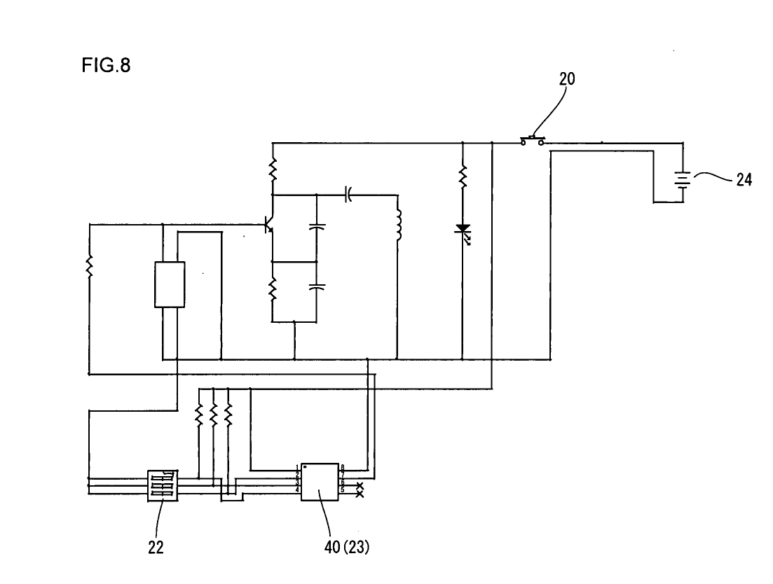

Next, the operation of the device 3 for suppressing roaring is described with reference to the circuit diagrams of FIGS. 7 and 8. When the dog barks, the barking is detected via the microphone 14, the audio signal picked up by the microphone 14 is transmitted through a transistor 25, a rectifier diode 26 and a condenser 27 for smoothing, and the signal is applied to a base of the transistor 28, according to which the transistor 28 is turned on. Thus, the transistor 29 is turned on, power supply voltage is applied to PIN 1 of PIC microcomputer 30 (corresponding to the control unit 16 of FIG. 5), and the PIC microcomputer 30 is turned on. Thus, according to the program installed to the PIC microcomputer 30, a HIGH signal is output from PIN 6 of the PIC microcomputer 30, based on which the transistor 31 and transistor 32 are turned on. When the transistor 31 is turned on, a self holding circuit of the PIC microcomputer 30 is activated. The self holding circuit starts a timer count from the time the PIC microcomputer 30 is turned on, so that the receiving mode is maintained only during a predetermined period of time set in advance (30 seconds according to the initial setting), and after the passing of the predetermined period of time, the receiving mode is cancelled to move on to a standby status (sleep status). When the transistor 32 is turned on, power supply voltage is applied to PIN 8 of the microcomputer 35 on the receiver 15, according to which the communication between the receiver 15 and transmitter 11 is enabled. Further, the communication between the receiver 15 and the transmitter 11 is enabled only during a predetermined period of time by the self holding circuit of the PIC microcomputer 30, and when no signal is received from the transmitter 11 during that predetermined period of time, the communication between the receiver 15 and the transmitter 11 is disabled. The pet owner can determine whether the barking is an unnecessary barking or not after hearing the barking, and if determined as an unnecessary bark, the owner manipulates the vibration switch 20 within a predetermined period of time, but if determined as a soft call for attention, the owner will not manipulate the vibration switch 20, so that no remote control signal is transmitted from the transmitter 11 to the receiver 15 during a predetermined period of time. After the passing of the predetermined period of time, the receiver 15 is turned off and enters a sleep status. On the other hand, when the vibration switch 20 is manipulated during the predetermined period of time, a transmission signal including an ID of a mode switch 22 connected to a PIC microcomputer 40 of the transmitter 11 (corresponding to a control unit 23 of FIG. 6) is output from PIN 7 of the microcomputer 40 of the transmitter 11 to the receiver 15. When the receiving unit 12 receives this signal from the transmitter 11, the PIC microcomputer 30 verifies the received signal of the transmitter 11 input via PIN 12 of the microcomputer 35 of the receiver 15, and determines whether the ID of the mode switch 19 of the receiver 15 connected to the PIC microcomputer 30 corresponds with the ID of the mode switch 22 of the transmitter 11. When the ID of the mode switch 19 corresponds with the ID of the mode switch 22 of the transmitter 11 at the PIC microcomputer 30, a signal is output from PIN 7 of the PIC microcomputer 30, and the transistor 36 functioning as a vibration control switch 17 is turned on to activate the vibration motor of the vibration unit 10. Thereby, the vibration motor is rotated to apply vibration to the pet, so as to suppress roaring of the pet.

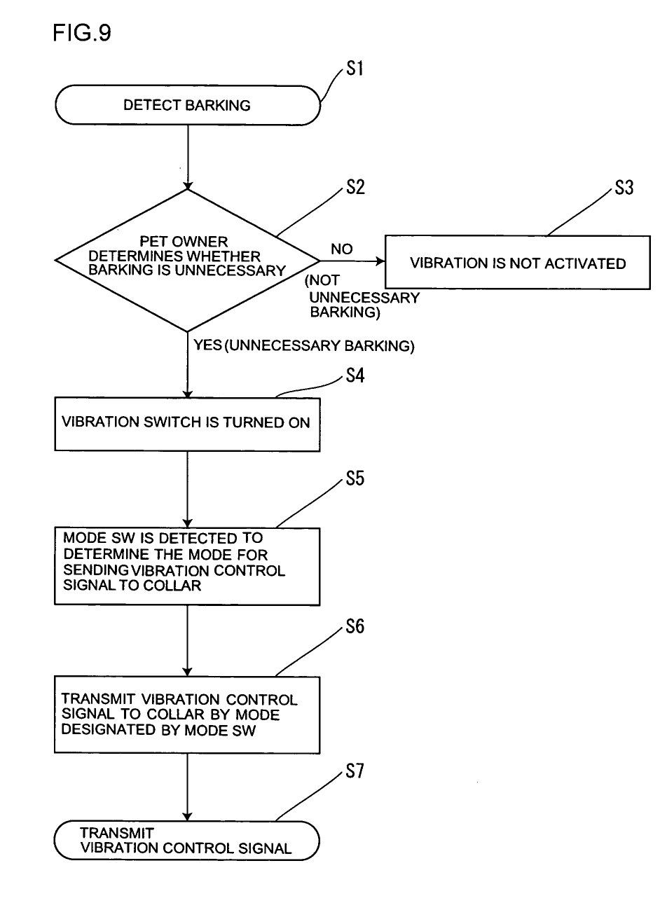

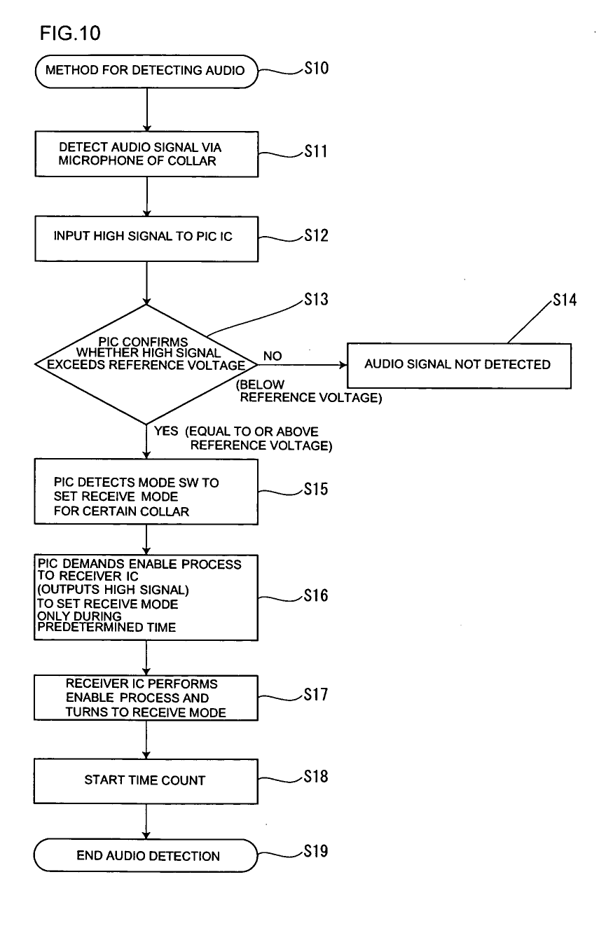

The operation and effect of the device 3 for suppressing roaring according to the present embodiment as arranged above will be described with reference to the flowcharts of FIGS. 9 through 11. At first when the dog barks, the pet owner determines whether the barking is an unnecessary bark or not (steps S1 and S2). That is, if the dog is making a fawning sound or the like to call for the attention of the owner, the owner will not activate via the transmitter 11 the vibration of the device 3 for suppressing roaring (step S3). On the other hand, when the owner determines that it is an unnecessary bark and wishes to stop the barking, he/she presses the vibration switch 20 on the transmitter 11 (step S4) based on which the transmitter detects the mode switch 22 selected in advance by the owner, and sends a vibration control signal to the receiver 15 on the collar 1 by the designated mode on the mode switch 22 (steps S5, S6 and S7). At the receiver 15 on the other hand, as shown in the flowchart of FIG. 10, when the dog barks, the barking is picked up via the microphone 14 and a HIGH signal is input to the PIC microcomputer 30 (control unit 16) (steps S10, S11, S12, S13). The PIC microcomputer 30 determines whether that HIGH signal exceeds a reference voltage (2.5 V) or not, and when it is below the reference voltage, the barking is not detected as audio (step S14). When the voltage is equal to or greater than the reference voltage, the procedure advances to step 15, where the PIC microcomputer 30 detects the mode switch 19 of the receiver 15 set up by the pet owner (step S15), and the PIC microcomputer 30 outputs an instruction to carry out an enable process (a process to enable communication between the receiver 15 and the transmitter 11) so that the receive mode is selected for a predetermined period of time, and according thereto, the receiver 15 is set to receive mode (steps S16 and S17). Then, the PIC microcomputer 30 starts the timer count (step S18), and maintains the receive mode for a predetermined time (30 seconds), and after the passing of the predetermined time, carries out a disable process (a process to disable the communication between the receiver 15 and the transmitter 11), so that the receiver 15 enters a sleep status (step S19).

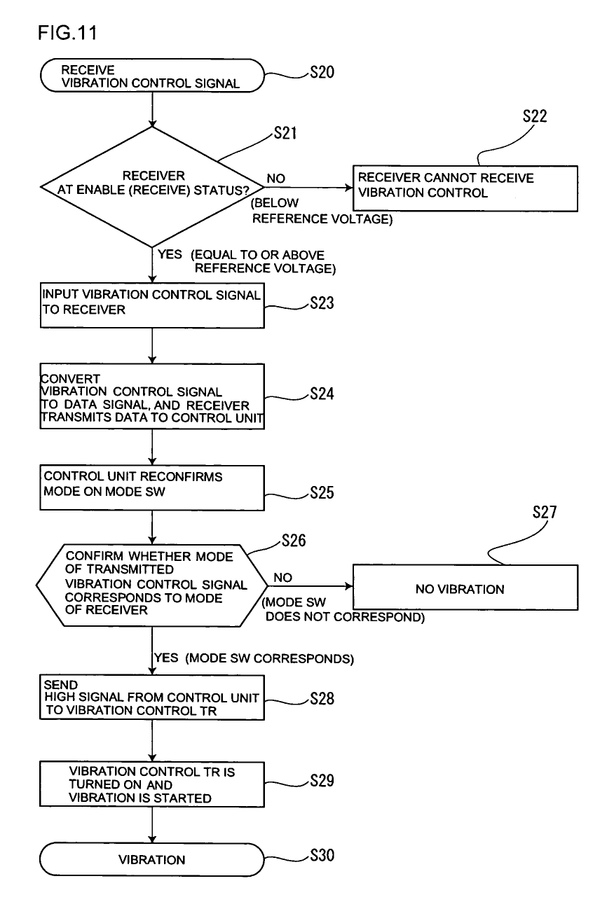

Next, the operation of the vibration unit 10 will be described with reference to the flowchart of FIG. 11. When the pet owner turns on the vibration switch 20 of the receiver 15, the vibration control signal is received by the receiving unit 12 of the receiver 15 (step S20). Then, it is determined whether the receiver 15 is at enable status or not (step S21). If the receiver 15 is at disable status, the receiver 15 cannot receive the vibration control signal (step S22), so the vibration unit 10 will not activate even if the pet owner erroneously presses the vibration switch 20. On the other hand, if the receiver 15 is at enable status, that is, if the receiver 15 is at receive mode based on the audio signal of the barking, the vibration control signal is output to the receiver 15. This vibration control signal is converted into a data signal and transmitted to the control unit 16 (PIC microcomputer 30) (steps S23 and S24). Then, the control unit 16 confirms the mode on the mode switch 19 (steps S25 and S26), and if the mode of the vibration control signal transmitted from the transmitter 11 and the mode on the receiver 15 does not correspond, it will not activate the vibration motor (step S27), so that the vibration unit 10 will not erroneously activate even if a remote control device for another electric appliance in the same frequency band is used. When the mode of the vibration control signal transmitted from the transmitter 11 and the mode of the receiver 15 correspond, a HIGH signal is output from the control unit 16, by which a transistor 36 functioning as the vibration control switch 17 is turned on and the vibration motor of the vibration unit 10 is activated. Thereby, the vibration motor is rotated, applying vibration to the pet and suppressing the roaring of the pet (steps S28, S29 and S30).

As described, according to the present embodiment, the receiver 15 is turned to receive mode for a predetermined period of time only when the barking of the dog is detected and the level of the audio signal is equal to or above a reference value, so that the receiver 15 will not be activated by the surrounding noise. Further, since the vibration unit 10 will not be activated by the manipulation of the transmitter 11 if the receiver is not at receive mode, the erroneous manipulation of the transmitter by the pet owner will not activate the vibration unit 10 causing unnecessary pain in the pet. Moreover, since the communication between the transmitter 11 and the receiver 15 is enabled only for a predetermined period of time after detecting the barking, the receiver 15 is not constantly at receive mode, so that the power consumed by the receiver 15 is small and the running cost is cut down. Furthermore, the pet owner can determine whether or not to activate the vibration unit 10, so that only when the pet owner determines that the barking is excessive, the vibration unit 10 is activated to let the pet now what kind of behavior (unnecessary barking) is bad. Therefore, the present device can be used to carry out effective training. In addition, by providing mode switches 19 and 22 to the transmitter 11 and the receiver 15, and to set the vibration unit 10 to activate only when the mode switches 19 and 22 correspond, it becomes possible to prevent the interference from the remote control signals for other electric appliances, and to prevent erroneous activation of the device 3 during use of other remote control switches. Moreover, if the mode switches 19 on multiple collars 1 on dogs are set to the same mode, the pet owner can stop the barking of multiple pet dogs using a single transmitter 11 when all the dogs bark at the same time. Since the mode switches 19 and 22 are placed near the battery housing units 25 and 26 for housing the batteries functioning as power supply units 18 and 24, the mode switches 19 and 22 can be switched easily by removing the battery lid 27.

One preferred embodiment of the present invention has been described in detail, but this embodiment is not meant to restrict the range of the present invention. For example, the arrangement of the collar 1, the engagement structure of the belt, the circuit arrangements of the transmitter 11 and receiver 15, the overall design thereof and so on are not limited to those illustrated in the present embodiment, and can be selected appropriately within the range of the present invention. Further, vibration is used as the means for suppressing the roaring, but other means such as audio or alarm can also be used to suppress roaring.

1. A device for suppressing roaring of pet by attaching to a collar of the pet, the device comprising:
a roaring suppressing means for suppressing the roaring of the pet by applying stimulus to the pet;
a transmitting means carried by a pet owner for remote-controlling the roaring suppressing means;
a receiving means for receiving a signal from the transmitting means; and
a control means for detecting the roaring of the pet, and controlling based on the detected audio signal to enable communication between the transmitting means and the receiving means for a predetermined period of time, and to disable communication between the transmitting means and the receiving means after the passing of the predetermined period of time.

2. The device for suppressing roaring of pet according to claim 1, wherein a plurality of mode switches are provided in the transmitting means and the receiving means, and the control means enables communication between the transmitting means and the receiving means when the mode switches of the transmitting means and the receiving means mutually correspond.

3. The device for suppressing roaring of pet according to claim 1, wherein the roaring suppressing means comprises a vibration unit for applying vibration to the pet.

4. The device for suppressing roaring of pet according to claim 2, wherein the roaring suppressing means comprises a vibration unit for applying vibration to the pet.
